(19) United States
(12) Patent Application Publication
(10) Pub. No.: US 2007/0222211 A1
(43) Pub. Date: Sep. 27, 2007

(54) Brake hose fitting and method of manufacture

(76) Inventors: David F. Reuter, Beavercreek, OH (US); Michael J. Chisom, Springboro, OH (US); Randall L. Green, Dayton, OH (US); Frank G. Pirrello, Dayton, OH (US)

Correspondence Address: DELPHI TECHNOLOGIES, INC., M/C 480-410-202, PO BOX 5052, TROY, MI, 48007, US

(21) Appl. No.: 11/389,845

(22) Filed: Mar. 27, 2006

(51) Int. Cl. F16L 33/00

(52) U.S. Cl. 285/256

(57) ABSTRACT

A brake hose fitting having a fitting body and an eyelet. The fitting body includes a mounting portion, an elongate portion and a crimping sleeve. The elongate portion defines a passage extending radially outwardly from an opening in the mounting portion. The crimping sleeve is located near the opposite end of the passage. The brake hose fitting also includes an eyelet. The eyelet has first and second ends with a bore extending therebetween. The eyelet also includes a radially projecting flange. First and second longitudinal sections of the eyelet are located on opposite sides of the flange. The first longitudinal section is at least partially disposed in the passage and has a radially exterior surface sealingly engaged with the fitting body. An annular space for receiving a brake hose is defined between the second longitudinal section of the eyelet and the crimping sleeve. A method of manufacture is also provided.

### BACKGROUND OF THE INVENTION

1. Field of the Invention

The present invention relates to brake hose fittings and, more particularly, to brake hose fittings commonly referred to as “banjo” fittings.

2. Description of the Related Art

Automotive vehicles having caliper brakes often employ brake hose fittings known as “banjo” fittings to connect a high pressure brake fluid line at a 90 degree angle to the axis of a brake fluid port on the brake assembly and that allows the brake fluid line to be connected at any rotational position relative to the port axis. In addition to being coupled to a fluid port on the brake assembly, such banjo fittings also typically include an eyelet and sleeve that is used to couple the opposite end of the banjo fitting to a brake hose. The banjo fitting is then used to communicate high pressure hydraulic brake fluid between the brake hose and the brake assembly.

In conventional banjo fittings, the eyelet is inserted into the interior passage of the brake hose. The surrounding sleeve is used to secure the brake hose in place, for example, by crimping the sleeve inwardly to securely hold the hose between the eyelet and crimped sleeve. The eyelet and sleeve may be positioned directly on the mounting portion of the banjo fitting that is in fluid communication with the port on the brake assembly, or, the banjo fitting may include an elongate tubular member that extends between the mounting portion of the banjo fitting and the eyelet and sleeve. The elongate tubular member is generally a metallic tubular member that is bent into a shape that is configured to fit the available space of a particular make and model of an automotive vehicle and place the eyelet and sleeve at a location where they can be joined to a brake hose.

The manufacture of such banjo fittings presents a number of challenges including an ever-present desire to reduce the cost of manufacture. One known solution to these challenges that is shown in FIG. 3. In the prior art banjo fitting 10 illustrated in FIG. 3, the mounting body 12 and the sleeve body 14 are both machined steel fittings. Banjo fitting 10 also includes an elongate tubular member 16 and a metal formed eyelet 18. A brazing operation is employed to ensure that the two opposite ends of tubular member 16 are properly sealed to allow banjo fitting 10 to convey hydraulic brake fluid at pressures up to 5,000 psi (34.5 MPa) without failure. The efficacy of banjo fitting 10 has been demonstrated by its incorporation in a large number of automotive vehicles. The brazing operation required in the manufacture of banjo fitting 10, however, is a batch process that requires significant error proofing and leak testing.

Efforts to reduce the number of parts or eliminate the brazing operation required to manufacture an alternative to banjo fitting 10 must overcome a number of obstacles. For example, the machining of a one piece brass fitting to provide a banjo fitting places a practical limit on the length of any elongate tubular member positioned between the mounting portion and eyelet of the banjo fitting. The external diameter of the eyelet, and consequently, the internal diameter of the bore extending through the eyelet, is limited by the internal diameter of the brake hose. To allow the eyelet to be used with conventional brake hoses, the internal diameter of the eyelet may be no larger than approximately 2.3 mm. When machining a bore through a brass fitting, the maximum practical limit of the length of such a bore is approximately 25 times the diameter of the bore. At greater lengths, tool breakage and lengthy machining times typically become prohibitive. The relationship between the diameter and practical length of the bore is not totally linear since column strength of the drill bit increases with the area of the drill bit cross section, nevertheless, a length limit of 25 times the diameter of the bore provides a relationship that can be effectively employed when designing actual manufacturing processes.

Thus, in any manufacturing process for a single piece brass banjo fitting having elongate tubular member that requires the bore of the tubular member to drilled by extending the drill bit through the eyelet, the internal diameter of the eyelet will limit the length of the tubular member and prevent such a tubular member from having a length of greater than 100 mm that is required in some automotive applications.

Various other methods of manufacturing banjo fittings that avoid the necessity of a brazing operation are also known in the prior art.

An improved brake hose fitting structure and a method of manufacture that does not require a brazing operation during the manufacture of the brake hose fitting is desirable.

### SUMMARY OF THE INVENTION

The present invention provides an improved brake hose fitting that can be efficiently manufactured. The brake hose fitting includes a fitting body and an eyelet wherein the eyelet can be sealingly joined to the fitting body by a staking operation.

The invention comprises, in one form thereof, a brake hose fitting that includes a fitting body and an eyelet. The fitting body includes a mounting portion that defines an opening extending through the mounting portion in a first direction. An elongate portion of the mounting body defines a passage extending from a first port to a second port. The passage defines a length between the first and second ports and an internal diameter wherein the internal diameter is substantially constant for a majority of the length. The first port of the passage is in fluid communication with the opening in the mounting portion and the passage extends radially outwardly from the opening. The fitting body also includes a crimping sleeve. The sleeve is disposed proximate the second port of the passage and is adapted to be crimped radially inwardly. The eyelet has a first end and an opposite second end. The eyelet defines a longitudinal bore extending through the eyelet from the first end to the second end. The eyelet includes a radially outwardly projecting flange disposed between the first and second ends. A first longitudinal section of the eyelet is disposed between the first end and the flange and a second longitudinal section of the eyelet is disposed between the second end and the flange. The first end of the eyelet projects through the second port of the passage with the first longitudinal section being at least partially disposed within the passage. The second longitudinal section of the eyelet is disposed within the crimping sleeve and defines an annular space between the second longitudinal section and the crimping sleeve. A radially exterior surface of the first longitudinal section of the eyelet is engaged with the fitting body in a fluid tight seal.

The invention comprises, in another form thereof, a brake hose fitting having a fitting body and an eyelet. The fitting body includes a mounting portion that defines an opening which extends through the mounting portion in a first direction. The fitting body also includes an elongate portion that defines a passage extending from a first port to a second port. The passage defines a length between the first and second ports and an internal diameter wherein the internal diameter is substantially constant for a majority of the length. The first port of the passage is in fluid communication with the opening in the mounting portion and the passage extends radially outwardly from the opening. The fitting body also includes a crimping sleeve. The sleeve is disposed proximate the second port of the passage and is adapted to be crimped radially inwardly. The eyelet has a first end and an opposite second end and defines a longitudinal bore extending through the eyelet from the first end to the second end. The eyelet also includes a radially outwardly projecting flange disposed between the first and second ends. A first longitudinal section of the eyelet is disposed between the first end and the flange and a second longitudinal section of the eyelet is disposed between the second end and the flange. The first end of the eyelet projects through the second port of the passage and the first longitudinal section of the eyelet is at least partially disposed within the passage. The second longitudinal section is disposed within the crimping sleeve and defines an annular space between the second longitudinal section and the crimping sleeve. A first radial projection is disposed on the first longitudinal section of the eyelet between the first end and the flange and projects radially outwardly therefrom. A second radial projection is also disposed on the first longitudinal section of the eyelet and is located between the first end and the first projection and projects radially outwardly therefrom. The second radial projection has an outer radial surface that defines a progressively larger diameter as the distance of the outer radial surface from the first end increases whereby the second radial projection centers the first longitudinal section in the passage as the second radial projection is inserted through the second port. A shoulder is disposed on the first longitudinal section of the eyelet between the first projection and the flange and projects radially outwardly therefrom. The first radial projection and the shoulder define a first groove located therebetween. The shoulder defines an outer diameter that is greater than outer diameters of the first and second projections and of an internal diameter of the second port. The eyelet is configured so that the first longitudinal section defines a first radially exterior maximum diameter, the second longitudinal section defines a second radially exterior maximum diameter and the radially outwardly projecting flange defines a third radially exterior maximum diameter, wherein the third diameter is greater than the first and second diameters and the first diameter is greater than the second diameter. A sealing mass is disposed within the first groove and secures the eyelet to the fitting body in a fluid tight seal. The sealing mass includes a plastically deformed portion of the fitting body disposed proximate the second port and displaced into the first groove by engagement with the shoulder.

The invention comprises, in still another form thereof, a method of manufacturing a brake hose fitting. The method includes providing an integral mass of material, defining a mounting portion and an elongate portion in the integral mass to thereby define a fitting body and forming an opening through a mounting portion of the fitting body. A passage is formed through the elongate portion of the fitting body wherein the passage extends from a first port to a second port. The passage defines a length between the first and second ports and has an internal diameter which is substantially constant for a majority of the length of the passage. The first port is in fluid communication with the opening in the mounting portion of the fitting body and the passage extends radially outwardly from the opening in the mounting portion. The fitting body is also provided with a crimping sleeve proximate the second port of the passage. The method further includes providing an eyelet wherein the eyelet has a first end and an opposite second end. The eyelet defines a longitudinal bore extending through the eyelet from the first end to the second end. The eyelet further includes a radially outwardly projecting flange disposed between the first and second ends wherein a first longitudinal section of the eyelet is disposed between the first end and the flange and a second longitudinal section of the eyelet is disposed between the second end and the flange. The method further includes inserting the first end of the eyelet through the second port and thereby at least partially disposing the first longitudinal section of the eyelet within the passage, defining an annular space between the second longitudinal section of the eyelet and the crimping sleeve wherein the annular space is adapted to receive a brake hose, and engaging a radially exterior surface of the first longitudinal section of the eyelet with the fitting body in a fluid tight seal.

An advantage of the present invention is that it provides a brake hose fitting structure and method of manufacture that provides a robust brake hose fitting that can be efficiently manufactured without the use of a brazing operation.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a fitting in accordance with the present invention.

FIG. 2 is a cross sectional view of the fitting of FIG. 1.

FIG. 3 is a cross sectional view of a prior art fitting.

FIG. 4 is a schematic partial cross sectional view of an insert member and its connection to the fitting.

FIG. 5 is a schematic partial cross sectional view of an alternative insert member and its connection to the fitting.

Corresponding reference characters indicate corresponding parts throughout the several views. Although the exemplification set out herein illustrates embodiments of the invention, in multiple forms, the embodiments disclosed below are not intended to be exhaustive or to be construed as limiting the scope of the invention to the precise forms disclosed.

### DETAILED DESCRIPTION OF THE INVENTION

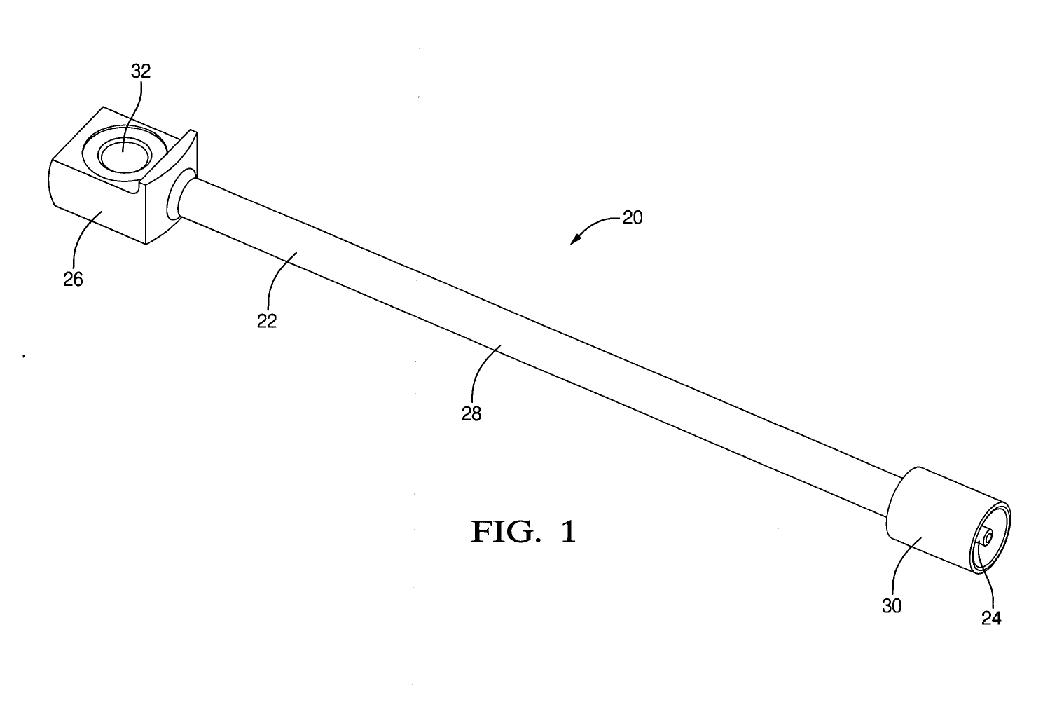

A brake hose fitting 20 in accordance with the present invention is shown in FIG. 1. Brake hose fitting 20 includes a fitting body 22 and an eyelet 24. Fitting body 22 has three main portions, a mounting portion 26, an elongate portion 28 and a crimping sleeve 30.

Fitting body 22 is advantageously formed out of an integral mass of material. In the illustrated embodiment, fitting body 22 is a machined brass fitting. Mounting portion 26 has an opening 32 that extends through mounting portion 26 in a first direction parallel to axis 34. When mounting fitting 20 to a brake assembly, an attachment fastener (not shown) is positioned to extend through opening 32 and secure fitting 20 to the brake assembly in a manner that allows for the selective rotational positioning of fitting 20 relative to the axis 34. Similar to a conventional banjo fitting 10, when installed, opening 32 is sealed at one end by the fastener assembly and is in fluid communication with the brake assembly at its opposite end.

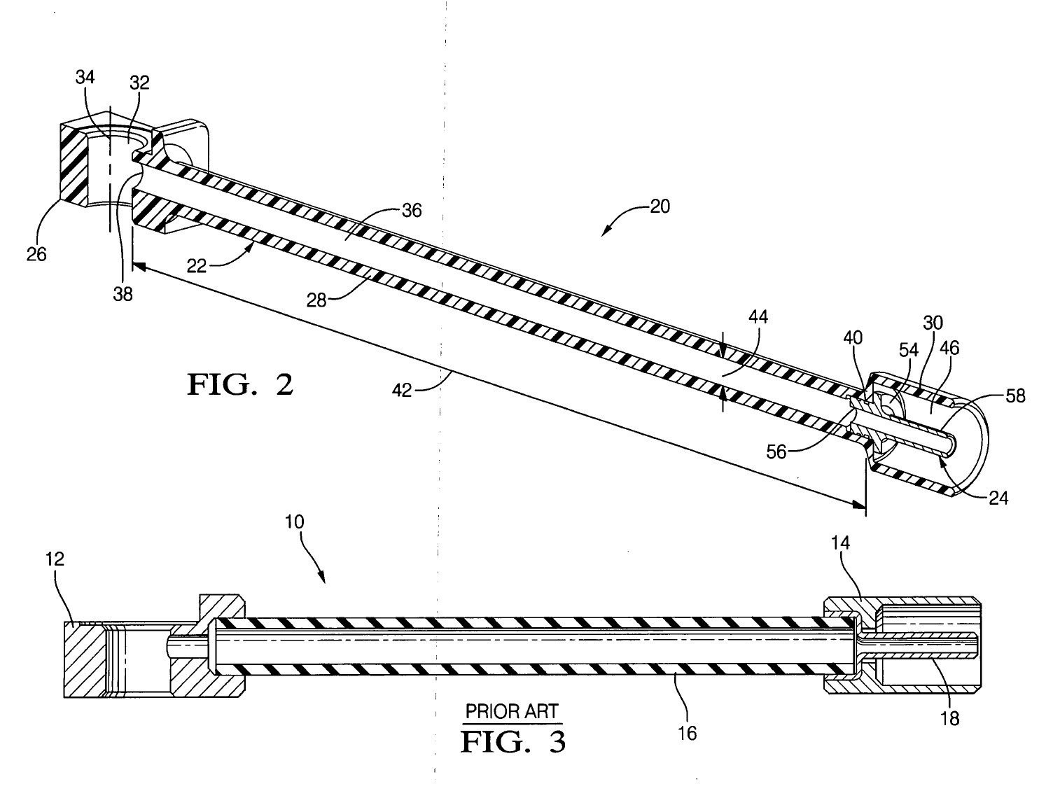

As best seen in FIG. 2, elongate portion 28 defines a passage 36 that extends from a first port 38 to a second port 40. Passage 36 defines a length 42 between first and second ports 36, 38. Although the formation of passage 36 may include secondary machining operations at second port 40 to define an enlarged diameter portion or stepped bore, which are discussed in greater detail below, the majority of passage 36 in embodiment 20 is formed by a single drilling operation and passage 36 defines an internal diameter 44 that is substantially constant for a majority of the length of the passage 36.

Length 42 of passage 36 is advantageously no greater than approximately 25 times internal diameter 44. This permits passage 36 to be drilled in a single operation without excessive tool breakage or machining times. Internal diameter 44 is advantageously at least as great as 4 mm whereby passage 36 may have a length 42 that is at least as great as 100 mm without being greater than 25 times internal diameter 44. The use of a relatively large internal diameter 44, i.e., a diameter of 4 mm or greater, not only facilitates the machining of passage 36 but also facilitates the flow of pressurized hydraulic brake fluid through passage 36 after elongate portion 28 has been bent into an “S” shape or other configuration to accommodate a specific automotive vehicle and installed on an automotive vehicle. In some embodiments of the present invention, elongate portion 28 may be formed with a passage 36 having a length 42 of at least 200 mm.

As best seen in FIG. 2, first port 38 of passage 36 is in fluid communication with opening 32 in mounting portion 26 with passage 36 extending radially outwardly from opening 32. As also seen in FIG. 2, fitting body 22 includes a crimping sleeve 30 located proximate second 40 of passage 36. An annular space 46 is formed between sleeve 30 and eyelet 24 for receiving the end of a brake hose.

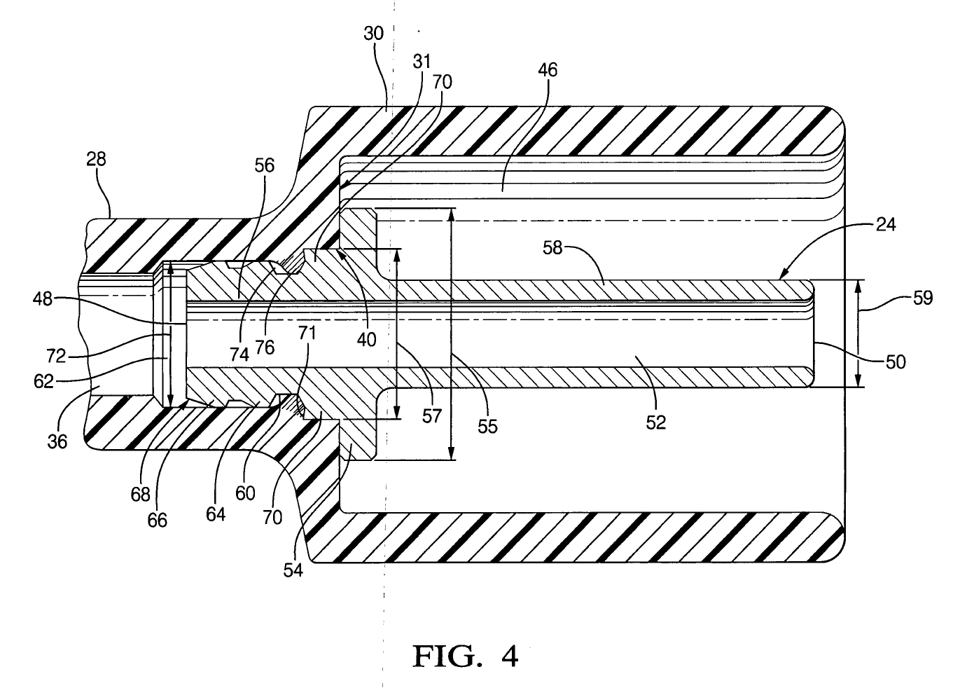

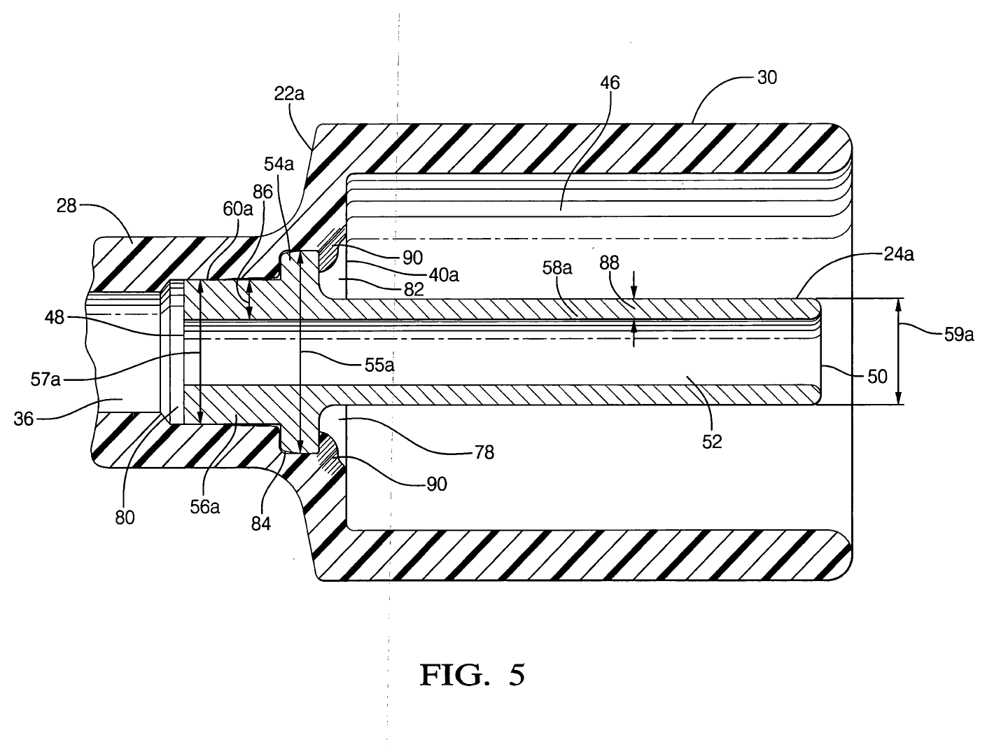

Two alternative embodiments of an eyelet 24, 24a are illustrated in FIGS. 4 and 5 of the present application. As discussed in greater detail below, second port 40a of the embodiment of FIG. 5 also differs from the first embodiment of FIG. 4. Both eyelets 24, 24a are advantageously formed out of a metal material that is harder than the material used to form sleeve portion 30. After eyelet 24, 24a is mounted in fitting body 22 and the end of a brake hose is seated in annular space 46, sleeve portion 30 is crimped inwardly to sealingly secure the brake hose within annular space 46. Forming eyelet 24, 24a out of a material having a relatively greater hardness than sleeve portion 30 facilitates the crimping of sleeve portion 30 radially inwardly to bear against a brake hose positioned in annular space 46 without causing the deformation of eyelet 24, 24a. In the illustrated embodiments, eyelets 24, 24a are formed out of a steel material while sleeve portion 30 is formed from brass. Eyelets 24, 24a may be manufactured using conventional manufacturing methods.

Eyelets 24, 24a each have a first end 48 and an opposite second end 50. A longitudinal bore 52 extends through the eyelets 24, 24a from first end 48 to second end 50. To facilitate its use with conventional brake hoses, longitudinal bore 52 has an internal diameter of approximately 2.3 mm. Alternative forms of the present invention, however, could be employed with eyelets having different dimensions.

In each of the illustrated embodiments, the eyelets 24, 24a include a radially outwardly extending flange 54, 54a located between the first end 48 and second end 50 of the eyelet 24, 24a and separating a first longitudinal section 56, 56a and a second longitudinal section 58, 58a of the eyelet. First end 48 of the eyelet 24, 24a is inserted through second port 40, 40a of the fitting body 22 during assembly. As a result, first end 48 and at least a portion of first longitudinal section 56, 56a projects through second port 40, 40a and is located within passage 36 after assembly. In each of the embodiments 24, 24a, a radially exterior surface 60, 60a of the first longitudinal section 56, 56a is engaged with the fitting body in a fluid tight seal.

Furthermore, in each of the embodiments of FIGS. 4 and 5, the first longitudinal sections 56, 56a define a first radially exterior maximum diameter 57, 57a the second longitudinal sections 58, 58a define a second radially exterior maximum diameter 59, 59a and the radially outwardly extending flanges 54, 54a define a third radially exterior maximum diameter 55, 55a wherein the third diameter 55, 55a is greater than both the first 57, 57a and second 59, 59a diameters and the first diameter 57, 57a is greater than the second diameter 59, 59a. In other words, the maximum outer diameter of flanges 54, 54a is greater than either of the first and second longitudinal sections, and the first longitudinal sections 56, 56a have a greater maximum outer diameter than the maximum outer diameters of the second longitudinal sections 58, 58a.

Features that differ between the two embodiments illustrated in FIGS. 4 and 5 will now be discussed. Turning first to the embodiment 24 of FIG. 4, passage 36 defines an enlarged internal diameter portion 62 adjacent second port 40. The first longitudinal section 56 of eyelet 24 is secured within enlarged diameter portion 62 as discussed below.

First longitudinal section 56 includes a first radial projection 64 disposed between first end 48 and flange 54. Projection 64 completely encircles first longitudinal section 56 and projects radially outwardly. A second encircling radial projection 66 is disposed on first longitudinal section 56 between first projection 64 and first end 48 and projects radially outwardly. As can be seen in FIG. 4, second projection 66 has as an outwardly flaring outer radial surface 68 that defines a progressively larger diameter as the distance of outer radial surface 68 from first end 48 increases. This configuration allows second radial projection 66 to center first longitudinal section 56 within passage 36 as first end 48 is being inserted through second port 40.

A shoulder 70 is also disposed on first longitudinal section 56 and is located between first projection 64 and flange 54. In the illustrated embodiment, shoulder 70 is located immediately adjacent flange 54, i.e., there is no annular groove or recess between shoulder 70 and flange 54. Shoulder 70 also projects radially outwardly and defines an outer diameter 57 that is greater than the outer diameters of first radial projection 64 and second radial projection 66 and of the internal diameter 72 of second port 40. As a result, when first end 48 is inserted through second port 40, first and second radial projections 64, 66 can be inserted through second port 40 without deforming first or second projection 64, 66 or the portion of fitting body 22 that surrounds second port 40. When larger diameter shoulder 70 interferingly encounters fitting body 22 at second port 40, however, it plastically deforms a portion of fitting body 22 surrounding second port 40 longitudinally and radially inwardly into first groove 74 defined between shoulder 70 and first radial projection 64.

The engagement of shoulder 70 with fitting body 22 is performed by a staking operation and forms a sealing mass 76, schematically depicted in FIG. 4, within groove 74 that mechanically secures eyelet 24 to fitting body 22 and also forms a fluid tight seal between the exterior surface 60 of first longitudinal section 56 and sealing mass 76 that is capable of providing a seal in the presence of fluid pressures up to at least 5,000 psi (34.5 MPa). Prior to deforming sealing mass 76 into groove 74 by engagement with shoulder 70, the enlarged diameter portion 62 is a cylindrical bore having a substantially constant internal diameter throughout its length.

As can be seen in FIG. 4, shoulder 70 has a raised edge 71 extending along the entirety of its outer circumference on the longitudinally oriented surface of shoulder 70 which faces first end 48 and engages an end face 31 of fitting body 22 that circumscribes port 40. Eyelet 24 is pressed into place with a force of approximately 5,000 pounds (22.2 kN). The sealing mass 76 which is deformed by this staking process and engaged with surface 60 in groove 74 is expected to maintain a fluid tight seal for pressures up to 10,000 psi (69 MPa) which is twice the design requirement of 5,000 psi (34.5 MPa). The extent to which eyelet 24 is forced into passage 36 is limited by engagement of flange 54 with end face 31. This limitation of the longitudinal insertion of eyelet 24 facilitates the control of the magnitude of fitting body material that is deformationally displaced during the formation of sealing mass 76.

A second embodiment 24a of an eyelet is illustrated in FIG. 5. The fitting body 22a used with eyelet 24a is the same as fitting body 22 illustrated in FIGS. 1, 2 and 4 except for the area surrounding second port 40a. As can be seen in FIG. 5, fitting body 22a defines a stepped bore 78 at second port 40a. More specifically, stepped bore 78 includes a first internal diameter portion 80 and a second diameter portion 82. Second portion 82 defines second port 40a and has a larger diameter than first internal diameter portion 80 which is in direct communication with the remainder of passage 36.

Unlike eyelet 24 which utilizes a shoulder to form a sealing mass to form a fluid tight seal between eyelet 24 and fitting body 22, eyelet 24a utilizes two press fit engagements between eyelet 24a and fitting body 22a to form the primary fluid tight seal between eyelet 24a and fitting body 22a.

Eyelet 24a has a first longitudinal section 56a with a radially exterior surface 60a that defines a substantially constant diameter 57a. Similarly, flange 54a has a radially exterior surface 84 that defines a substantially constant diameter 55a. These two surfaces 57a, 84 respectively engage the first internal diameter portion 80 and the second internal diameter portion 82 of stepped bore 78 in press fit engagements to form fluid tight seals between surfaces 57a, 84 and fitting body 22a after press fitting eyelet 24a into stepped bore 78. To facilitate the press fit engagement of eyelet 24a into stepped bore 78, either or both of surfaces 57a, 84 may have a slight outward flare wherein the diameter of the surface grows progressively larger as the distance of the surface from first end 48 increases.

Because first longitudinal section 56a has a greater outer diameter 57a than the outer diameter 59a of second longitudinal section 58a and bore 52 has a substantially constant diameter, eyelet 24a defines a first wall thickness 86 in first longitudinal section 56a and a second wall thickness 88 in second longitudinal section 58a wherein the first wall thickness 86 is greater than the second wall thickness 88.

After eyelet 24a has been press fit into stepped bore 78, a staking process is used to deform a mass of material integral with fitting body 22a and surrounding port 40a. This staking process forms a staked mass portion 90 that projects radially inwardly into stepped bore 78 adjacent flange 54a. Staked mass portion 90 engages flange 54a and thereby prevents the longitudinal withdrawal of flange 54a from stepped bore 78. This staking process also provides an additional fluid tight engagement between fitting body 22a and eyelet 24a.

While this invention has been described as having an exemplary design, the present invention may be further modified within the spirit and scope of this disclosure. This application is therefore intended to cover any variations, uses, or adaptations of the invention using its general principles.

What is claimed is:

1. A brake hose fitting, said fitting comprising:
a fitting body, said body including:
a mounting portion, said mounting portion defining an opening extending through said mounting portion in a first direction;
an elongate portion, said elongate portion defining a passage extending from a first port to a second port, said passage defining a length between said first and second ports and an internal diameter, said internal diameter being substantially constant for a majority of said length, said first port of said passage being in fluid communication with said opening in said mounting portion, said passage extending radially outwardly from said opening; and
a crimping sleeve, said sleeve disposed proximate said second port of said passage, said sleeve adapted to be crimped radially inwardly; and
an eyelet, said eyelet having a first end and an opposite second end and defining a longitudinal bore extending through said eyelet from said first end to said second end; said eyelet including a radially outwardly projecting flange disposed between said first and second ends wherein a first longitudinal section is disposed between said first end and said flange and a second longitudinal section is disposed between said second end and said flange; said first end of said eyelet projecting through said second port of said passage with said first longitudinal section at least partially disposed within said passage, said second longitudinal section disposed within said crimping sleeve and defining an annular space between said second longitudinal section and said crimping sleeve; a radially exterior surface of said first longitudinal section of said eyelet being engaged with said fitting body in a fluid tight seal.

2. The brake hose fitting of claim 1 wherein said eyelet is configured with said first longitudinal section defining a first radially exterior maximum diameter, said second longitudinal section defining a second radially exterior maximum diameter and said radially outwardly projecting flange defining a third radially exterior maximum diameter, said third diameter being greater than said first and second diameters and said first diameter being greater than said second diameter.

3. The brake hose fitting of claim 1 wherein said length of said passage is no greater than approximately 25 times said internal diameter of said passage, said internal diameter being greater than 2.3 mm.

4. The brake hose fitting of claim 3 wherein said internal diameter is at least as great as 4 mm and said length of said passage is at least as great as 100 mm.

5. The brake hose fitting of claim 1 further comprising:
a first radial projection disposed on said first longitudinal section between said first end and said flange and projecting radially outwardly therefrom;
a shoulder disposed on said first longitudinal section between said first projection and said flange and projecting radially outwardly therefrom, said first radial projection and said shoulder defining a first groove located therebetween; said shoulder defining an outer diameter greater than both said first projection and an internal diameter of said second port; and
a sealing mass disposed within said first groove and securing said eyelet to said fitting body in a fluid tight seal, said sealing mass comprising a plastically deformed portion of said fitting body disposed proximate said second port and displaced into said first groove by engagement with said shoulder.

6. The brake hose fitting of claim 5 further comprising:
a second radial projection disposed on said first longitudinal section between said first end and said first projection and projecting radially outwardly therefrom, said second radial projection having an outer radial surface that defines a progressively larger diameter as the distance of said outer radial surface from said first end increases and whereby said second radial projection centers said first longitudinal section in said passage as said second radial projection is inserted through said second port, said outer diameter of said shoulder being greater than an outer diameter of said second projection.

7. The brake hose fitting of claim 5 wherein said shoulder is disposed immediately adjacent said flange.

8. The brake hose fitting of claim 5 wherein said passage defines an enlarged internal diameter portion adjacent said second port, said first longitudinal section being disposed within said enlarged internal diameter portion of said passage.

9. The brake hose fitting of claim 5 wherein said eyelet is configured with said first longitudinal section defining a first radially exterior maximum diameter, said second longitudinal section defining a second radially exterior maximum diameter and said radially outwardly projecting flange defining a third radially exterior maximum diameter, said third diameter being greater than said first and second diameters and said first diameter being greater than said second diameter.

10. The brake hose fitting of claim 1 wherein said passage defines a stepped bore proximate said second port, said stepped bore defining a first internal diameter portion and a second internal diameter portion, said second internal diameter portion defining said second port and having a diameter greater than said first internal diameter portion; said first longitudinal section being engaged with said fitting body in a fluid tight press fit engagement within said first internal diameter portion of said stepped bore and said flange being engaged with said fitting body in a fluid tight press fit engagement within said second internal diameter portion of said stepped bore; and
a staked mass portion of said fitting body disposed adjacent said flange and preventing withdrawal of said flange from said stepped bore, said staked mass portion being integral with said fitting body and projecting radially inwardly into said stepped bore.

11. The brake hose fitting of claim 10 wherein said eyelet is configured with said first longitudinal section defining a first radially exterior maximum diameter, said second longitudinal section defining a second radially exterior maximum diameter and said radially outwardly projecting flange defining a third radially exterior maximum diameter, said third diameter being greater than said first and second diameters and said first diameter being greater than said second diameter.

12. The brake hose fitting of claim 11 wherein said first longitudinal section has a radially exterior surface that defines a substantially constant diameter.

13. The brake hose fitting of claim 12 wherein said eyelet defines a first wall thickness in said first longitudinal section and a second wall thickness in said second longitudinal section, said first wall thickness being greater than said second wall thickness.

14. A brake hose fitting, said fitting comprising:
a fitting body, said body including:
a mounting portion, said mounting portion defining an opening extending through said mounting portion in a first direction;
an elongate portion, said elongate portion defining a passage extending from a first port to a second port, said passage defining a length between said first and second ports and an internal diameter, said internal diameter being substantially constant for a majority of said length, said first port of said passage being in fluid communication with said opening in said mounting portion, said passage extending radially outwardly from said opening; and
a crimping sleeve, said sleeve disposed proximate said second port of said passage, said sleeve adapted to be crimped radially inwardly; and
an eyelet, said eyelet having a first end and an opposite second end and defining a longitudinal bore extending through said eyelet from said first end to said second end; said eyelet including a radially outwardly projecting flange disposed between said first and second ends wherein a first longitudinal section is disposed between said first end and said flange and a second longitudinal section is disposed between said second end and said flange; said first end of said eyelet projecting through said second port of said passage with said first longitudinal section at least partially disposed within said passage, said second longitudinal section disposed within said crimping sleeve and defining an annular space between said second longitudinal section and said crimping sleeve;
a first radial projection disposed on said first longitudinal section between said first end and said flange and projecting radially outwardly therefrom;
a second radial projection disposed on said first longitudinal section between said first end and said first projection and projecting radially outwardly therefrom, said second radial projection having an outer radial surface that defines a progressively larger diameter as the distance of said outer radial surface from said first end increases and whereby said second radial projection centers said first longitudinal section in said passage as said second radial projection is inserted through said second port;
a shoulder disposed on said first longitudinal section between said first projection and said flange and projecting radially outwardly therefrom, said first radial projection and said shoulder defining a first groove located therebetween; said shoulder defining an outer diameter greater than each of an outer diameter of said first projection, an outer diameter of said second projection, and an internal diameter of said second port;
wherein said eyelet is configured with said first longitudinal section defining a first radially exterior maximum diameter, said second longitudinal section defining a second radially exterior maximum diameter and said radially outwardly projecting flange defining a third radially exterior maximum diameter, said third diameter being greater than said first and second diameters and said first diameter being greater than said second diameter; and
a sealing mass disposed within said first groove and securing said eyelet to said fitting body in a fluid tight seal, said sealing mass comprising a plastically deformed portion of said fitting body disposed proximate said second port and displaced into said first groove by engagement with said shoulder.

15. The brake hose fitting of claim 14 wherein said shoulder is disposed immediately adjacent said flange.

16. The brake hose fitting of claim 14 wherein said passage defines an enlarged internal diameter portion adjacent said second port, said first longitudinal section being disposed within said enlarged internal diameter portion of said passage.

17. A method of manufacturing a brake hose fitting, said method comprising:
providing an integral mass of material;
defining a mounting portion and an elongate portion in the integral mass to thereby define a fitting body;
forming an opening through a mounting portion of the fitting body;
forming a passage through the elongate portion of the fitting body wherein the passage extends from a first port to a second port, the passage defining a length between the first and second ports, the passage having an internal diameter which is substantially constant for a majority of the length of the passage, the first port being in fluid communication with the opening in the mounting portion and the passage extending radially outwardly from the opening in the mounting portion;
providing the fitting body with a crimping sleeve proximate the second port of the passage;
providing an eyelet, the eyelet having a first end and an opposite second end and defining a longitudinal bore extending through the eyelet from the first end to the second end, the eyelet further including a radially outwardly projecting flange disposed between the first and second ends wherein a first longitudinal section is disposed between the first end and the flange and a second longitudinal section is disposed between the second end and the flange;
inserting the first end of the eyelet through the second port and thereby at least partially disposing the first longitudinal section of the eyelet within the passage;
defining an annular space between the second longitudinal section of the eyelet and the crimping sleeve wherein the annular space is adapted to receive a brake hose; and
engaging a radially exterior surface of the first longitudinal section of the eyelet with the fitting body in a fluid tight seal.

18. The method of claim 17 wherein the eyelet is configured with the first longitudinal section defining a first radially exterior maximum diameter, the second longitudinal section defining a second radially exterior maximum diameter and the radially outwardly projecting flange defining a third radially exterior maximum diameter, the third diameter being greater than the first and second diameters and the first diameter being greater than the second diameter.

19. The method of claim 17 wherein the passage has an internal diameter greater than 2.3 mm.

20. The method of claim 17 wherein the step of forming a passage through the elongate portion of the fitting body includes drilling the passage through the elongate portion and wherein the length of the passage is no greater than approximately 25 times the internal diameter of the passage, the length of the passage being at least as great as 100 mm and the internal diameter of the passage being at least as great as 4 mm.

21. The method of claim 17 wherein the eyelet includes a first radial projection disposed on the first longitudinal section between the first end and the flange and projecting radially outwardly from the first longitudinal section, and a shoulder disposed on the first longitudinal section between the first projection and the flange and projecting radially outwardly from the first longitudinal section; the first projection and the shoulder defining a first groove located therebetween, the first shoulder defining an outer diameter greater than both the first projection and an internal diameter of the second port; and wherein the step of inserting the first end of the eyelet through the second port further includes:
engaging the shoulder with the fitting body proximate the second port and deforming a portion of the fitting body to form a sealing mass that is disposed within the first groove to thereby secure the eyelet to the fitting body and form a fluid tight seal between the eyelet and the fitting body.

22. The method of claim 17 wherein the passage defines a stepped bore proximate the second port, the stepped bore defining a first internal diameter portion and a second internal diameter portion, the second internal diameter portion defining the second port and having a greater diameter than the first internal diameter portion; and wherein the step of inserting the first end of the eyelet through the second port further includes:
engaging the first longitudinal section with the fitting body within the first internal diameter portion of the stepped bore in a fluid tight press fit engagement;
engaging the flange with the fitting body within the second internal diameter portion of the stepped bore in a fluid tight press fit engagement; and
wherein after the flange is positioned in the second internal diameter portion of the stepped bore, the method further includes staking the fitting body wherein a portion of the fitting body proximate the second port forms a staked mass that projects radially inwardly and is disposed adjacent the flange and prevents the withdrawal of the flange from the stepped bore.
